(19) United States
(12) Patent Application Publication
(10) Pub. No.: US 2010/0166311 A1
(43) Pub. Date: Jul. 1, 2010

(54) DIGITAL IMAGE PROCESSING APPARATUS AND METHOD OF CONTROLLING THE SAME

(75) Inventor: Jae-hyun Kang, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/634,891

(22) Filed: Dec. 10, 2009

(30) Foreign Application Priority Data
Dec. 26, 2008 (KR) 10-2008-0134963

(51) Int. Cl. G06K 9/00; H04N 5/50

(52) U.S. Cl. 382/181; 348/569

(57) ABSTRACT

A digital image processing apparatus and a method of controlling the digital image processing apparatus are provided. The digital image processing apparatus, and associated method, may display on-screen display (OSD) regions which do not overlap a face zone display box after determining whether the face zone display box and the OSD regions overlap each other.

### CROSS-REFERENCE TO RELATED PATENT APPLICATIONS

This application claims the benefit of Korean Patent Application No. 10-2008-0134963, filed on Dec. 26, 2008 in the Korean Intellectual Property Office, the entire contents of which is incorporated herein by reference.

### BACKGROUND OF THE INVENTION

1. Field of the Invention

The present invention relates to a digital image processing apparatus and a method of controlling the same. More particularly, the present invention relates to a digital image processing apparatus for improving user convenience by determining whether a face zone display box and an on-screen display (OSD) region overlap and displaying an OSD region that does not overlap with the face zone display box. The present invention also relates to a method of controlling the digital image processing apparatus.

2. Description of the Related Art

In general, digital image processing apparatuses include apparatuses such as digital cameras, personal digital assistants (PDAs), mobile phone cameras, and PC cameras which process images or use a motion sensor. Digital image processing apparatuses receive desired images through an image pickup device, display the input images on an image display device, store the images as image files according to a selection of the user, and print the stored image files. In recent times, facial recognition algorithms have been incorporated into such conventional digital image processing apparatuses.

FIGS. 1A and 1B are diagrams schematically showing examples of a face zone display box and on-screen display (OSD) regions in an image including a person, for example. Referring to FIG. 1A, the digital image processing apparatus of the conventional art generally displays a face zone display box B1 and a plurality of OSD regions OSD1-OSD6 together. However, when the face zone display box B1 and the plurality of OSD regions OSD1-OSD6 are displayed together, some of the OSD regions (for example, OSD3 in FIG. 1A) may overlap the face zone display box B1. In this case, because the OSD region blocks the face of a subject, a photographer cannot exactly recognize the face of the subject.

On the other hand, FIG. 1B shows a case where the entire OSD regions are turned off. In this case, although the photographer may recognize the face of the subject displayed in the face zone display box B2, the information displayed in the OSD regions cannot be obtained in real-time.

### SUMMARY OF THE INVENTION

The present invention provides a digital image processing apparatus for improving user convenience by determining overlapping between a face zone display box and on-screen display (OSD) regions and displaying an OSD region that does not overlap the face zone display box. The present invention also provides a method of controlling the digital image processing apparatus.

According to an embodiment of the present invention, a digital image processing apparatus having a face recognition function is provided. The digital image processing apparatus includes a digital signal processor which determines whether a face zone display box and on-screen display (OSD) regions overlap each other, and displays OSD regions which do not overlap the face zone display box.

The digital signal processor may include: a face recognition unit performing face recognition; a face recognition zone display unit displaying a face zone display box on a recognized face region; an OSD information detector detecting information of the OSD regions; an OSD region display unit displaying the OSD regions; and an overlapping determination unit determining whether the face zone display box and the OSD regions overlap each other.

The overlapping determination unit may determine whether each of the plurality of OSD regions and the face zone display box overlap each other.

The OSD region display unit may only display the ODS regions which do not overlap the face zone display box, from among the plurality of OSD regions.

The OSD region display unit may turn off the OSD regions which do not overlap the face zone display box or may process the OSD regions which do not overlap the face zone display unit to be translucent.

When entire parts of some OSD regions from among the plurality of OSD regions overlap the face zone display box, the OSD region display unit may not display the overlapping OSD regions or may process the overlapping OSD regions to be translucent.

When some parts of some OSD regions from among the plurality of OSD regions overlap the face zone display box, the OSD region display unit may not display the overlapping OSD regions or may process the overlapping OSD regions to be translucent.

When some parts of some OSD regions from among the plurality of OSD regions overlap the face zone display box, the OSD region display unit may not display the overlapping parts of the OSD regions or may process the overlapping parts of the OSD regions to be translucent, and may display remaining parts of the OSD regions.

The overlapping determination unit may determine the overlapping by comparing coordinate and size information of the face zone display box with coordinate and size information of the plurality of OSD regions. According to another embodiment of the present invention, a method of controlling a digital image processing apparatus having a face recognition function is provided. The method includes: detecting face recognition information from a live-view image; displaying a face zone display box according to the detected face recognition information; calculating information of OSD regions that are to be displayed; determining whether the face zone display box and the plurality of OSD regions overlap each other; and turning on/off the display of OSD regions according to a result of the determining.

A plurality of OSD regions may be formed, the determining of the overlapping between the face zone display box and the plurality of OSD regions may include determining whether each of the plurality of OSD regions and the face zone display box overlap each other.

The turning on/off of the display of OSD regions according to the result of the determining of the overlapping of the face zone display box and the plurality of OSD regions may include only displaying the OSD regions which do not overlap the face zone display box from among the plurality of OSD regions.

The turning on/off of the display of OSD regions according to the result of the determining of the overlapping of the face zone display box and the plurality of OSD regions may not display the OSD regions which overlap the face zone display box from among the plurality of OSD regions, or may process the overlapping OSD regions to be translucent.

When entire parts of some OSD regions from among the plurality of OSD regions overlap the face zone display box, the turning on/off of the display of OSD regions according to the result of the determining of the overlapping of the face zone display box and the plurality of OSD regions may not show the overlapping OSD regions or may process the overlapping OSD regions to be translucent.

When some parts of some OSD regions from among the plurality of OSD regions overlap the face zone display box, the turning on/off of the display of OSD regions according to the result of the determining of the overlapping of the face zone display box and the plurality of OSD regions may not show the overlapping OSD regions or may process the overlapping OSD regions to be translucent.

When some parts of some OSD regions from among the plurality of OSD regions overlap the face zone display box, the turning on/off of the display of OSD regions according to the result of the determining of the overlapping of the face zone display box and the plurality of OSD regions may not show the parts overlapping the face zone display box or may process the parts overlapping the face zone display box to be translucent, and may represent remaining parts, which do not overlap the face zone display box, of some OSD regions that overlap the face zone display box.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are diagrams schematically showing examples of a face zone display box and on-screen display (OSD) regions in an image including a person;

FIG. 2 is a block diagram of an example of a digital image processing apparatus according to an embodiment of the present invention;

FIG. 3 is a detailed block diagram of an example of a digital signal processor in the digital image processing apparatus shown in FIG. 2;

FIGS. 4A-4C are diagrams showing examples in which some OSD regions are not displayed according to a face recognition result and an OSD information detection result with regard to an image including a person; and

FIG. 5 is a flowchart illustrating examples of processes of controlling a digital image processing apparatus according to an embodiment of the present invention.

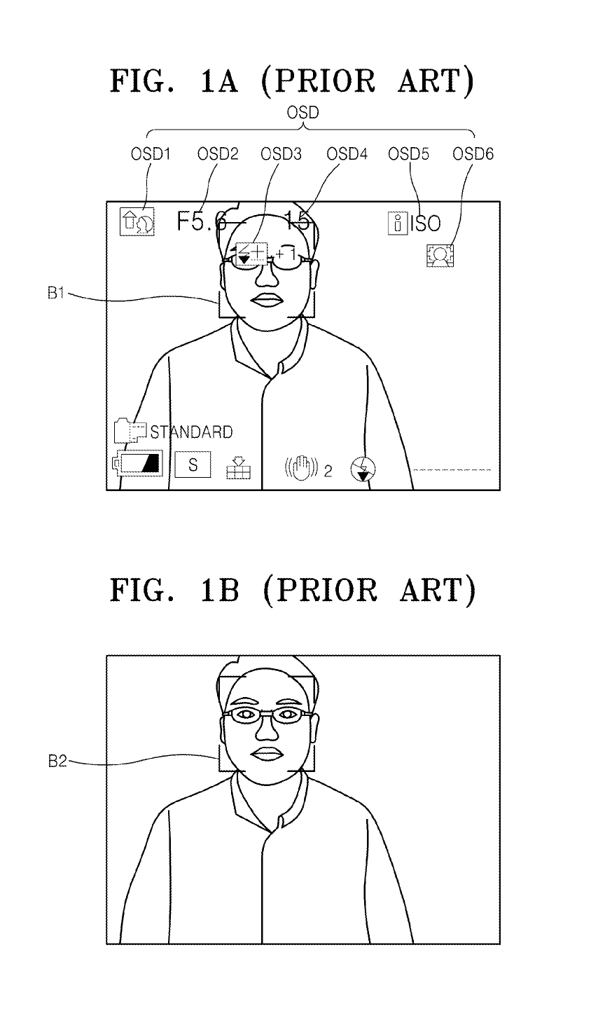

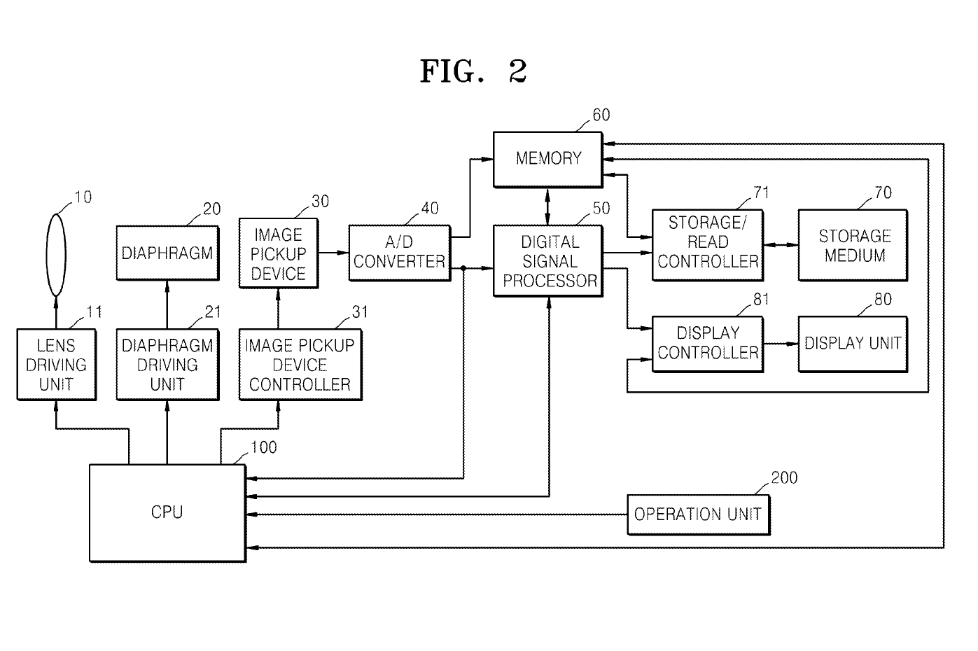

### DETAILED DESCRIPTION OF THE INVENTION

Hereinafter, a digital image processing apparatus and a method of controlling the digital image processing apparatus will be described with reference to accompanying drawings.

FIG. 2 is a block diagram of an example of a digital image processing apparatus according to an embodiment of the present invention. In particular, FIG. 2 schematically shows a digital photographing apparatus as an example of the digital image processing apparatus. The present invention is not limited to the digital photographing apparatus shown in FIG. 2, and may be applied to image processing apparatuses such as personal digital assistants (PDAs) and personal multimedia players (PMPs), for example.

All operations of the digital photographing apparatus are controlled by a central processing unit (CPU) 100. In addition, the digital photographing apparatus includes an operation unit 200 including keys for generating electric signals input from a user. The electric signals of the operation unit 200 are transferred to the CPU 100 so that the CPU 100 may control the digital photographing apparatus according to the electric signals.

In a photographing mode, when an electric signal from the user is applied to the CPU 100, the CPU 100 checks the electric signal to control a lens driving unit 11, a diaphragm driving unit 21, and an image pickup device controller 31.

Accordingly, a location of a lens 10, an opening degree of a diaphragm 20, and sensitivity of the image pickup device 30 are adjusted. The image pickup device 30 generates data from input light, and an analog/digital (A/D) converter 40 converts the analog data output from the image pickup device 30 into digital data. The A/D converter 40 may not be necessary according to the characteristic of the image pickup device 30.

The data output from the image pickup device 30 may be input into a digital signal processor 50 after passing through a memory 60, or may be input into the digital signal processor 50 without passing through the memory 60. Otherwise, the data output from the image pickup device 30 may be input into the CPU 100. Here, the memory 60 may include a read only memory (ROM) or a random access memory (RAM).

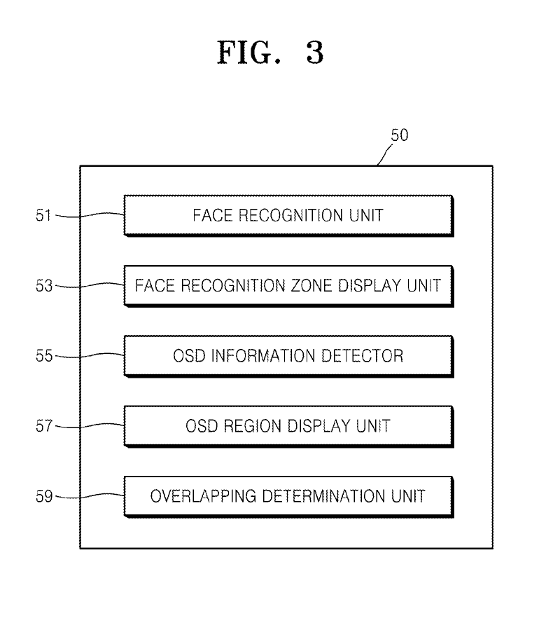

The digital signal processor 50 may perform digital signal processing such as gamma compensation and white balance adjustment. In addition, as shown in the example of FIG. 3, the digital signal processor 50 may include a face recognition unit 51, a face recognition zone display unit 53, an on-screen display (OSD) information detector 55, an OSD region display unit 57, and an overlapping determination unit 59. The face recognition unit 51, the face recognition zone display unit 53, the OSD information detector 55, the OSD region display unit 57, and the overlapping determination unit 59 may be modified. For example, the above elements may not all be included in the digital signal processor 50. That is, it is enough when the digital photographing apparatus of the present embodiment includes the face recognition unit 51, the face recognition zone display unit 53, the OSD information detector 55, the OSD region display unit 57, and the overlapping determination unit 59. Operations of the face recognition unit 51, the face recognition zone display unit 53, the OSD information detector 55, the OSD region display unit 57, and the overlapping determination unit 59 will be described later.

Images of the data output from the digital signal processor 50 are transferred to a display controller 81 directly or via the memory 60. The display controller 81 controls a display unit 80 to display images on the display unit 80. In addition, the data output from the digital signal processor 50 is input to a storage/read controller 71 directly or via the memory 60, and the storage/read controller 71 stores the image data in a storage medium 70 automatically or according to a signal from the user. The storage/read controller 71 may read data from a moving picture file stored in the storage medium 70, and inputs the data into the display controller 81 via the memory 60 or via other paths to display the moving pictures on the display unit 80. The storage medium 70 may be detachable or fixedly mounted in the digital photographing apparatus, for example.

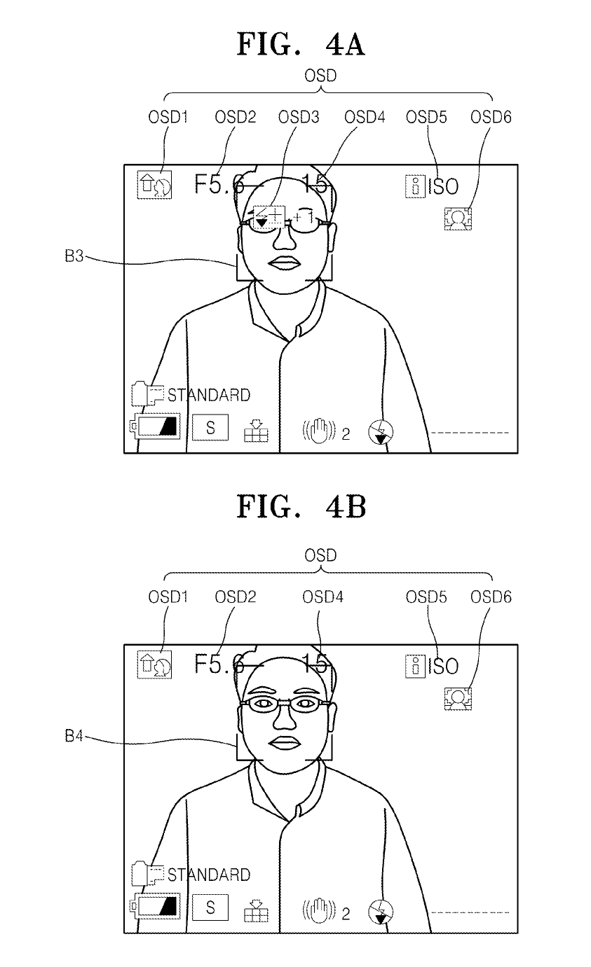

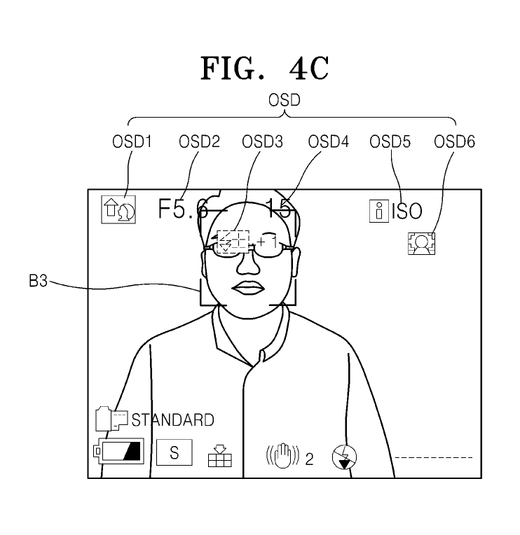

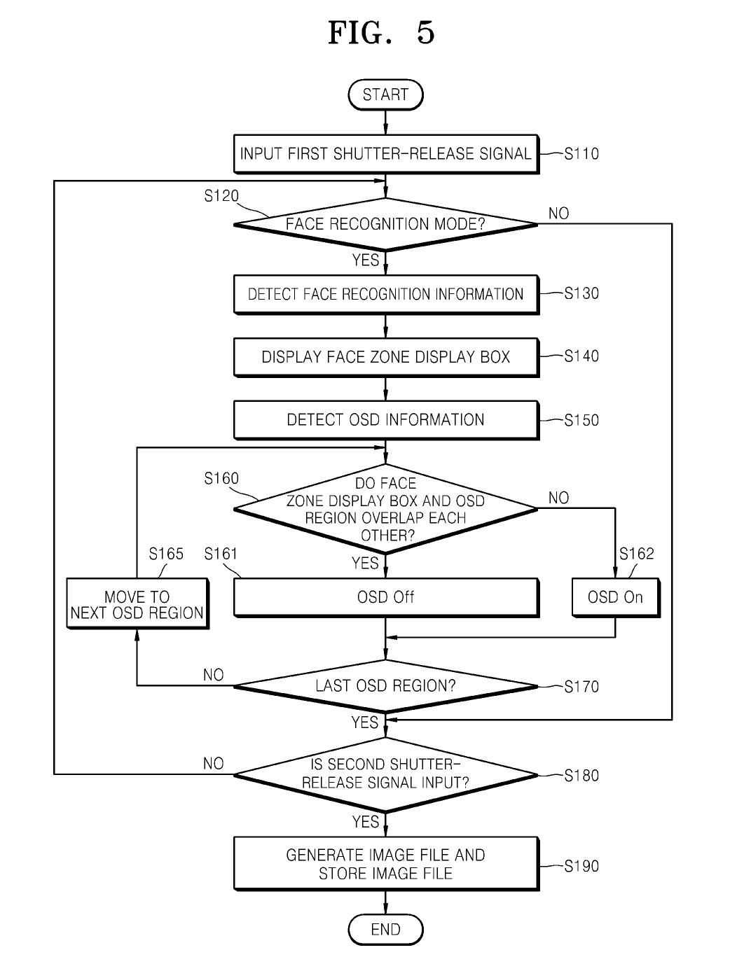

Hereinafter, functions of the face recognition unit 51, the face recognition zone display unit 53, the OSD information detector 55, the OSD region display unit 57, and the overlapping determination unit 59 will be described with reference to the examples of FIGS. 3 and 4.

FIG. 3 is a detailed block diagram of an example of the digital signal processor 50 in the digital photographing apparatus according to an embodiment of the present invention. The digital signal processor 50 includes the face recognition unit 51, the face recognition zone display unit 53, the OSD information detector 55, the OSD region display unit 57, and the overlapping determination unit 59. When the face recognition region and the OSD region overlap each other, the digital signal processor 50 of the example of FIG. 3 controls the overlapped OSD region to be turned off.

The face recognition unit 51 detects one or more faces from an image that includes people, for example. The face recognition unit 51 searches for unchangeable facial properties (elements such as eyes, nose, and mouth, texture, and skin tone, for example) to detect the faces. Among the facial properties, skin tone is the least sensitive to movement, rotation, and change in size of the face, and thus, is most frequently used as a reference in face recognition. Otherwise, according to a face template based detection method, a few reference patterns of the face are made, and then, the reference patterns are stored to detect the face. After that, the patterns are compared with the images in a search window of the image to detect the face.

In recent times, face detection methods based on support vector machine (SVM) methods have been widely utilized as an example of the face detection method. According to the methods based on the SVM methods, a number of regions are sub-sampled from an image to determine the face zone and non-face zone, and then, the face is found in the input image. Since the face detection of the face recognition unit 51 is well known in the art, a detailed description thereof will be omitted here.

The face recognition zone display unit 53 displays a face zone display box of the recognized face region in the display unit (for example, 80 in FIG. 2). According to the current face recognition functionality, a square recognition zone, that is, the face recognition region, exists on the face of the subject, and the face recognition region may reduce or increase according to a distance between the subject and the lens 10.

The OSD information detector 55 calculates coordinate and size information of each OSD region from among the plurality of OSD regions that will be displayed on the display unit (refer, for example, to 80 in FIG. 2), and the OSD region display unit 57 displays each of the plurality of OSD regions on the display unit (for example, 80 in FIG. 2).

The overlapping determination unit 59 determines whether the face zone display box and each of the OSD regions overlap by comparing the coordinate and size information of the face zone display box with the coordinate and size information of each OSD region. Since each of the plurality of OSD regions is compared with the face zone display box, the OSD regions that do not overlap the face zone display box from among the plurality of OSD regions may be displayed on the display unit (for example, 80 in FIG. 2).

FIGS. 4A and 4B are diagrams showing examples in which some of the OSD regions are not displayed according to the face recognition result and the OSD information detection result with regard to the image including the person.

Referring to the examples of FIGS. 3, 4A, and 4B, the face recognition unit 51 detects the face of subject from the image including the subject, and the face recognition zone display unit 53 displays a face zone display box B3 of the recognized face on the display unit (for example, 80 in FIG. 2). Next, the OSD information detector 55 calculates coordinate information of each OSD regions from among the plurality of OSD regions OSD1-OSD6 that will be displayed on the display unit (for example, 80 in FIG. 2). In addition, the overlapping determination unit 59 determines whether the face zone display box B3 and the OSD regions OSD1-OSD6 overlap by comparing the coordinate information of the face zone display box B3 with the coordinate information of each OSD region OSD1-OSD6.

In FIG. 4A, the OSD region OSD3 overlaps the face zone display box B3. Therefore, as shown in the example of FIG. 4B, the OSD region display unit 57 displays the OSD regions on the display unit (for example, 80 in FIG. 2) except for the OSD region OSD3 that overlaps the face zone display box B4. Otherwise, the OSD region OSD3 that overlaps the face zone display box B4 is not completely turned off, but is displayed to be translucent (FIG. 4C) so that the OSD region OSD3 and the face zone display box B4 may be simultaneously displayed.

On the other hand, in the drawings, the OSD region is turned off or becomes translucent only when the entire OSD region is included in the face zone display box. However, the present invention is not limited to the above examples. That is, the OSD regions OSD2 and OSD4, some parts of which are included in the face zone display box B4, may be turned off or become translucent, as well as the OSD region OSD3, all of which is included in the face zone display box B4. Moreover, the OSD region OSD3, the entire part of which is included in the face zone display box B4, is completely turned off, and some parts of the OSD regions OSD2 and OSD4 included in the face zone display box B4 may become translucent. Besides, various ways of preventing the OSD regions from interfering with the face zone display box may be derived from the specification of the present invention.

On the other hand, the present invention may be applied to a case where various display regions displayed on the display unit such as an auto focus (AF) box overlap the OSD regions.

According to the present invention, convenience for a user of the digital photographing apparatus may be improved since the face region of the subject may be easily identified.

Hereinafter, a method of controlling the digital image processing apparatus will be described with reference to the flowchart shown in the example of FIG. 5. The method of controlling the digital image processing apparatus may be performed in the digital photographing apparatus illustrated in the examples of FIGS. 2 and 3. A main algorithm of the controlling method may be performed in the digital signal processor 50 with the help of peripheral elements in some embodiments.

FIG. 5 is a flowchart illustrating examples of processes of controlling a digital image processing apparatus according to an embodiment of the present invention. Referring to the example of FIG. 5, the method of controlling the digital image processing apparatus according to the present embodiment may include detecting face recognition information (S130), displaying a face zone display box (S140), detecting OSD information (S150), determining whether the face zone display box and the OSD regions overlap (S160), and turning on/off the OSD regions according to the determination result (S161/S162).

First, when a user inputs a first shutter-release signal (S110), the digital signal processor 50 determines whether a photographing mode is a face recognition mode or not (S120).

When the photographing mode is not the face recognition mode, a standby state is maintained until a second shutter-release signal is input (S180).

On the other hand, when the photographing mode is the face recognition mode, the face recognition information is detected (S130). In more detail, the face recognition unit detects one or more faces from an image including people. The face recognition unit searches for unchangeable facial properties (elements such as eyes, nose, and mouth, texture, and skin tone) to detect the faces. Among the facial properties, skin tone is the least sensitive to movement, rotation, and change in size of the face, and thus, is most frequently used as a reference in face recognition. Otherwise, according to a face template based detection method, a few reference patterns of a face are made, and then, the reference patterns are stored to detect the face. After that, the patterns are compared with the images in a search window of the image to detect the face.

Next, the face zone display box is displayed (S140). In more detail, the face recognition zone display unit displays the face zone display box of the recognized face region on the display unit. According to the current face recognition function, a square recognition zone, that is, the face recognition region, exists on the face of the subject, and the face recognition region may reduce or increase according to a distance between the subject and the lens

Next, OSD information is detected (S150). That is, the OSD information detector calculates coordinate information of the plurality of OSD regions that will be displayed on the display unit, and extracts the information such as location and size of each of the plurality of OSD regions. Here, each of the plurality of OSD regions may denote various information such as photographing mode, F number, and ISO (International Standards Organization) information.

Next, it is determined whether the face zone display box and the OSD regions overlap each other (S160). In more detail, the overlapping determination unit compares the coordinate information of the face zone display box and the coordinate information of each of the plurality of OSD regions to determine whether the face zone display box and each of the plurality of OSD regions overlap each other. Since each OSD region is compared with the face zone display box, only the OSD region that does not overlap the face zone display box from among the plurality of OSD regions may be displayed on the display unit.

According to the above determination, when the face zone display box and the OSD region overlap each other, the corresponding OSD region is turned off (S161). Otherwise, the corresponding OSD region may be made translucent without being turned off completely.

On the other hand, according to the above determination, when the face zone display box and the OSD region do not overlap each other, the corresponding OSD region is turned on (S162) to be displayed on the display unit.

According to the above description, the OSD region is turned off or made translucent only when the entire part of the OSD region is included in the face zone display box. However, the present invention is not limited to the above description.

That is, the OSD region, a part of which is included in the face zone display box, may be turned off or made translucent, as well as the OSD region, all of which is included in the OSD region. Moreover, the OSD region, all of which is included in the face zone display box, may be completely turned off while the parts of the OSD regions included in the face zone display box may become translucent. Furthermore, various ways of preventing the OSD regions from interfering with the face zone display box may be derived from the specification of the present invention.

In addition, it is determined whether the OSD region, the overlapping of which is determined, is the last OSD region or not (S170). When the OSD region is not the last OSD region, the processes from S160 are repeated for the next OSD region. When the OSD region is the last OSD region, it is determined whether the second shutter-release signal is input (S180). According to the determination result of S180, when the second shutter-release signal is not input, the processes from S120 are repeated. That is, if the location of the face zone display box is changed because the user changes the position of the photographing apparatus, it is determined whether the face zone display box and the OSD region overlap each other again, and then, only the OSD regions that do not overlap the face zone display box are displayed.

When the second shutter-release signal is input from the user, the captured image is processed as a joint photographic experts group (JPEG) image file, for example, and then, the JPEG image file, for example, is displayed on the display unit and stored in a storage unit (S190).

According to the present invention, the face zone of the subject may be easily identified, and accordingly, user convenience may be improved.

While the present invention has been particularly shown and described with reference to exemplary embodiments thereof, it will be understood by those having ordinary skill in the art that various changes in form and details may be made therein without departing from the spirit and scope of the present invention as defined by the following claims.

What is claimed is:

1. A digital image processing apparatus having a face recognition function, the digital image processing apparatus comprising:
a digital signal processor determining whether a face zone display box and on-screen display (OSD) regions overlap each other, and displaying OSD regions which do not overlap the face zone display box.

2. The digital image processing apparatus of claim 1, wherein the digital signal processor comprises:
a face recognition unit performing face recognition;
a face recognition zone display unit displaying a face zone display box on a recognized face region;
an OSD information detector detecting information of the OSD regions;
an OSD region display unit displaying the OSD regions; and
an overlapping determination unit determining whether the face zone display box and the OSD regions overlap each other.

3. The digital image processing apparatus of claim 2, wherein the overlapping determination unit determines whether each of the plurality of OSD regions and the face zone display box overlap each other.

4. The digital image processing apparatus of claim 3, wherein the OSD region display unit only displays the ODS regions which do not overlap the face zone display box, from among the plurality of OSD regions.

5. The digital image processing apparatus of claim 3, wherein the OSD region display unit turns off the OSD regions which do not overlap the face zone display box or processes the OSD regions which do not overlap the face zone display unit to be translucent.

6. The digital image processing apparatus of claim 3, wherein when entire parts of some OSD regions from among the plurality of OSD regions overlap the face zone display box, the OSD region display unit may not display the overlapping OSD regions or may process the overlapping OSD regions to be translucent.

7. The digital image processing apparatus of claim 3, wherein when some parts of some OSD regions from among the plurality of OSD regions overlap the face zone display box, the OSD region display unit may not display the overlapping OSD regions or may process the overlapping OSD regions to be translucent.

8. The digital image processing apparatus of claim 3, wherein when some parts of some OSD regions from among the plurality of OSD regions overlap the face zone display box, the OSD region display unit may not display the overlapping parts of the OSD regions or may process the overlapping parts of the OSD regions to be translucent, and may display remaining parts of the OSD regions.

9. The digital image processing apparatus of claim 2, wherein the overlapping determination unit determines the overlapping by comparing coordinate and size information of the face zone display box with coordinate and size information of the plurality of OSD regions.

10. A method of controlling a digital image processing apparatus having a face recognition function, the method comprising:
detecting face recognition information from a live-view image;
displaying a face zone display box according to the detected face recognition information;
calculating information of OSD regions that are to be displayed;
determining whether the face zone display box and the plurality of OSD regions overlap each other; and
turning on/off the display of OSD regions according to a result of the determining.

11. The method of claim 10, wherein a plurality of OSD regions are formed, the determining of the overlapping between the face zone display box and the plurality of OSD regions includes determining whether each of the plurality of OSD regions and the face zone display box overlap each other.

12. The method of claim 11, wherein the turning on/off of the display of OSD regions according to the result of the determining of the overlapping of the face zone display box and the plurality of OSD regions comprises only displaying the OSD regions which do not overlap the face zone display box from among the plurality of OSD regions.

13. The method of claim 11, wherein the turning on/off of the display of OSD regions according to the result of the determining of the overlapping of the face zone display box and the plurality of OSD regions may not display the OSD regions which overlap the face zone display box from among the plurality of OSD regions, or may process the overlapping OSD regions to be translucent.

14. The method of claim 11, wherein when entire parts of some OSD regions from among the plurality of OSD regions overlap the face zone display box, the turning on/off of the display of OSD regions according to the result of the determining of the overlapping of the face zone display box and the plurality of OSD regions may not show the overlapping OSD regions or may process the overlapping OSD regions to be translucent.

15. The method of claim 11, wherein when some parts of some OSD regions from among the plurality of OSD regions overlap the face zone display box, the turning on/off of the display of OSD regions according to the result of the determining of the overlapping of the face zone display box and the plurality of OSD regions may not show the overlapping OSD regions or may process the overlapping OSD regions to be translucent.

16. The method of claim 11, wherein when some parts of some OSD regions from among the plurality of OSD regions overlap the face zone display box, the turning on/off of the display of OSD regions according to the result of the determining of the overlapping of the face zone display box and the plurality of OSD regions may not show the parts overlapping the face zone display box or may process the parts overlapping the face zone display box to be translucent, and may represent remaining parts, which do not overlap the face zone display box, of some OSD regions that overlap the face zone display box.
